(19) United States
(12) Patent Application Publication
(10) Pub. No.: US 2014/0267078 A1
(43) Pub. Date: Sep. 18, 2014

(54) Input Differentiation for Touch Computing Devices

(71) Applicant: ADOBE SYSTEMS INCORPORATED, San Jose, CA (US)

(72) Inventors: Timothy Kukulski, Oakland, CA (US); Geoffrey Dowd, San Francisco, CA (US)

(73) Assignee: ADOBE SYSTEMS INCORPORATED, San Jose, CA (US)

(21) Appl. No.: 13/835,959

(22) Filed: Mar. 15, 2013

(51) Int. Cl. G06F 3/041; G06F 3/038

(52) U.S. Cl. CPC G06F 3/0416; G06F 3/0383
USPC 345/173; 345/179

(57) ABSTRACT

Methods for differentiating touch inputs are disclosed. A method detects a touch input by receiving contact at a computing device's touch surface and identifies whether the touch input was received from a stylus based on additional input received from the stylus. The method responds to the touch input, wherein the response differs based on whether the touch input was received from the stylus. The detecting, identifying and responding are performed at the computing device. A stylus has a capacitive tip, a wireless transceiver, and a pressure sensor for determining a pressure level received at the tip. The stylus determines if a pressure level measured by the pressure sensor has reached a threshold, suppresses capacitive output from the tip to a touch surface if it is determined that the threshold has not been reached, and communicates a message to the computing device based on determining that the threshold has been reached.

### TECHNICAL FIELD

This disclosure relates generally to electronic computing devices and more particularly relates to processing touch inputs into touch screen computing devices.

### BACKGROUND

Conventional touch screen computing devices have been configured to identify the positioning and/or movement of one or more fingers or other objects on or near touch surfaces of the devices. For example, touch screens associated with some touch computing devices have been configured for receiving input via finger gestures and to perform one or more functions in response to those finger gestures. Certain touch screen computing devices can receive input from input devices such as stylus devices. A stylus is a writing, drawing, or pointing instrument or utensil that is generally configured to be hand held and, in the context of touch screen computing devices, used to interact with a touch surface. For example, touch screen computing devices have identified input based on one end of the stylus moving on or near the touch surface of the computing device. Styluses (or styli) have been used with personal digital assistant devices, tablet computing devices, smart phones, and other touch screen computing devices for handwriting, drawing, selecting icons, and providing other forms of input to such touch computing devices.

There are three general categories of stylus devices: active styli, pressure sensitive styli, and ‘dumb’ styli. Dumb styli have no internal electronic components, no batteries, and typically only have a capacitive rubber tip at an end of a pen-shaped body. Such styli are unable to detect amounts or levels of pressure applied via their tips onto a display of a touch computing device. Active styli are self-contained systems designed to work with specific, usually proprietary, touch computing devices. Active styli may include radios or other means to communicate with a particular touch device/platform and are typically limited to working with a proprietary touch screen interface of a closed, proprietary system. Such active styli are constrained to working with a given platform because other, third party touch computing platforms and devices will not recognize these closed-system styli as valid input devices.

In contrast to active styli, pressure sensitive styli are often designed to work with third party touch screens and touch computing devices not made by the manufacturer of such styli. Example pressure sensitive styli are described in more detail in U.S. patent application Ser. No. 13/572,231 entitled “Multifunctional Stylus”, filed Aug. 10, 2012, which is incorporated by reference herein in its entirety. The tips of pressure sensitive may include pressure-sensitive elements. Pressure sensitive styli seek to provide multiple levels of pressure sensitivity, which can be useful in drawing, graphics, and other touch-based applications. For example, pressure sensitive styli can be used to sketch a drawing and provide other touch inputs to applications such as Adobe® Ideas®, Adobe® Illustrator®, and Adobe® Photoshop® executing on various touch computing devices and platforms such as tablet computing devices and smart phones.

Styli that are capable of sensing or detecting levels of pressure can be used to provide more types of controls, data, gestures, and other contact inputs to touch computing devices and touch-based applications. Such pressure sensitivity can be achieved via use of pressure sensitive tips and sensors. Some prior touch-based applications have not taken full advantage of the array of inputs produced by pressure sensitive styli, particularly when the inputs are combined with, and/or augmented by, touch inputs using other means, such as fingers and palms. The limited amount of contact detection and input differentiation performed by such applications can decrease their ease of use, compatibility with other applications, and user efficiency.

Traditional techniques for detecting pressure levels as a component of touch inputs and are limited in terms of contact detection and levels of pressure that can be detected. This limits the types of inputs and gestures that can be processed. These techniques are also unable to effectively and quickly differentiate input received from a stylus versus other means, such as fingers and palms. Some touch-based applications recognize and process application-specific touch inputs. Traditional touch-based applications and touch computing devices do not utilize input timing information to differentiate and distinguish inputs received via stylus contacts versus inputs received via finger touches and gestures.

As such, inputs including a combination of stylus contacts with a touch surface of a touch computing device and finger touches may not be recognized or definable in touch-based applications. For example, some touch based platforms and touch computing devices are limited to recognizing a single touch input means at a time. Such platforms and devices may toggle between accepting inputs from a stylus and fingers, but do not recognize simultaneous input from multiple input means. The lack of support for hybrid stylus-finger touch inputs decreases user productivity by requiring that some application workflows and operations include more and/or different steps in one touch computing device as compared to another touch computing device. Similarly, some touch-based applications do not support inputs or workflows that include stylus and touch inputs from other means such as fingers. The lack of cross-application support for touch inputs limits functionality, reduces user friendliness, and presents additional disadvantages.

### SUMMARY

Disclosed herein are methods and systems for differentiating contacts and other inputs received from pressure sensitive styli from touch inputs received from other means such as fingers and palms. Workflows for touch computing devices and touch applications based on libraries of input sequences, including inputs received from styli and other means, are disclosed. Methods for differentiating stylus inputs from other touch inputs based on pressure levels and timing information received from a stylus are disclosed.

According to one exemplary embodiment, a computer implemented detects a touch input by receiving a physical contact made at a touch surface of a computing device and identifies whether the touch input was received from a stylus based on additional input received from the stylus. The method includes responding to the touch input with a response, wherein the response differs based on whether the touch input was received from the stylus. The detecting, identifying and responding are performed at the computing device.

According to another exemplary embodiment, a computer implemented method includes detecting a first touch input and a second touch input, the first touch input detected by receiving a physical contact at a touch surface of a computing device, the second touch input detected by receiving a second physical contact at the touch surface of the computing device. The method also includes associating the first touch input with a first type of touch input and the second type of touch input with a second type of touch input different from the first type and then responding to first touch input and the second touch input with a response based on the first type and the second type, wherein the detecting, determining, associating, and responding are performed by a computing device.

In another exemplary embodiment, a computer readable medium has instructions stored thereon, that, if executed by a processor of a computing device, cause the computing device to perform operations for differentiating input received at a touch surface of the computing device. The instructions include instructions for detecting a touch input by receiving a physical contact made at a touch surface of the computing device, instructions for identifying whether the touch input was received from a stylus based on additional input received from the stylus. The instructions also include instructions for responding to the touch input with a response, wherein the response differs based on whether the touch input was received from the stylus.

According to yet another exemplary embodiment, a stylus has a capacitive tip configured to interact with a touch surface of a computing device. The stylus includes a wireless transceiver configured to communicate with the computing device and a pressure sensor configured to determine a level of pressure received at the tip. The stylus also has a processor and a computer readable medium having logic encoded thereon, that if executed by the processor, cause the processor to perform operations. The operations comprise determining if a level of pressure measured by the pressure sensor has reached a predetermined threshold, suppressing capacitive output from the tip to the touch surface if the determining determines that the threshold has not been reached, and communicating a message to the computing device based on determining that the threshold has been reached.

These illustrative features are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented. The structure and operation of various embodiments are described in detail below with reference to the accompanying drawings. Such embodiments are presented herein for illustrative purposes only. Additional embodiments will be apparent to persons skilled in the relevant art(s) based on the teachings contained herein.

### BRIEF DESCRIPTION OF THE FIGURES

Exemplary embodiments are best understood from the following detailed description when read in conjunction with the accompanying drawings. It is emphasized that, according to common practice, the various features of the drawings are not to scale. On the contrary, the dimensions of the various features may be arbitrarily expanded or reduced for clarity. Included in the drawings are the following figures:

FIG. 1 provides a perspective view of a pressure sensitive stylus, according to certain embodiments;

FIG. 2 provides an interior perspective view of the stylus illustrated in FIG. 1;

FIG. 3 is a block diagram depicting exemplary computing devices and systems for implementing certain embodiments;

FIG. 4 depicts exemplary forms of touch input capable of being provided by an exemplary stylus;

FIG. 5 depicts exemplary touch inputs for modifications, menu selections, and other touch inputs capable of being recognized and processed by an exemplary touch based computing device;

FIGS. 6-18 illustrate exemplary touch inputs and workflows that can be implemented using the stylus illustrated in FIG. 1, the system shown in FIG. 3, and the touch inputs depicted in FIGS. 4 and 5, according to certain embodiments;

FIG. 19 is a flowchart illustrating an exemplary method for detecting and reporting pressure for a touch input device; and

FIG. 20 is a diagram of an exemplary computer system in which embodiments of the present disclosure can be implemented.

Embodiments of the present invention will now be described with reference to the accompanying drawings. In the drawings, generally, common or like reference numbers indicate identical or functionally similar elements. Additionally, generally, the left-most digit(s) of a reference number identifies the drawing in which the reference number first appears.

### DETAILED DESCRIPTION

Methods and systems are disclosed for a pressure sensitive stylus that functions as a device for interacting with one or more touch based applications executable on touch computing devices. The stylus may also function as a wireless transceiver for transmitting input and content between the stylus and the computing devices. In one embodiment, a user may pair the stylus with one or more touch computing devices, such as for example, a tablet computer, a smart phone with a touch screen interface, and/or any other touch computing device. The user may then cause one or more actions to be performed on the touch computing device by interacting with the touch computing device using the stylus. The actions can form part of one of a plurality of workflows defined in a workflow library. For example, the actions performed on the touch computing device may be specific to the application being executed by the touch computing device when the interaction occurs, and the application may access the library of workflows to process input received from the stylus.

In embodiments, a touch application is able to differentiate between input received via a stylus and finger or palm based on the capacitive difference between the stylus tip and the finger or palm. In alternative embodiments, in cases where capacitive difference information is not available to the touch application, i.e., due to platform features of the touch computing device the application is running on, such as, but not limited to, its operating system (OS) and characteristics of its touch screen, input differentiation is achieved by comparing timing between the computing device's touch information and pressure information retrieved by the stylus. The computing device itself, depending on the platform and/or OS, may not deliver any pressure information to the touch application. In these cases, embodiments use the stylus to provide pressure information to the touch application. In certain embodiments, the stylus functions as a pressure sensor that sends pressure information to the touch application via a wireless transceiver of the stylus 111 (i.e., via a Bluetooth transceiver). An exemplary stylus can do this very quickly (in near real time—in less than 40 milliseconds in one non-limiting embodiment) so that the timing of the stylus is closely aligned with that of the touch computing device. In an embodiment, this same timing information can then also be used to distinguish between contact from the stylus and contact from a finger or palm.

According to embodiments, a method detects physical contact made by a first input means at a touch surface of a touch computing device, determines a pressure level corresponding to the detected contact. The computing device receives first and second inputs from the first input means, and then associates, based at least in part on the second input, first input means with a type of input means.

In an embodiment, a stylus can provide timing data, such as, for example, a timestamp corresponding to the first input so that the touch computing device will recognize the first and second inputs as coming from the stylus, instead of other means such as a finger, fingers, or a palm. In another embodiment, if the touch computing device determines that a received pressure level meets a predetermined, tunable pressure level threshold associated with a stylus, the touch computing device will recognize the first and second inputs as coming from the stylus.

According to embodiments, if the touch computing device receives a pressure level or a modulated pressure stream via a capacitive tip of a stylus, the touch computing device will recognize the first and second inputs as coming from the stylus.

In another embodiment, if the touch computing device determines that a pressure level has reached or exceeded a predefined, tunable threshold and also receives a timestamp from the means associated with the first and/or second inputs, the touch computing device will recognize the first and second inputs as coming from the stylus.

In certain embodiments, the touch computing device and/or touch applications executing on the touch computing device is configured to recognize stylus or other touch inputs received on the touch computing device's touch surface. In embodiments, the inputs, can include, but are not limited to, a single tap, a long press on the touch surface, a swipe in a cardinal direction, a flick, a double tap, a pinch, a two-finger press, a three-finger press, a draw selection, a paint selection, an erase selection, a button click, and an extended button press (i.e., a button press and hold). Embodiments include software libraries or other means for correlating, by the touch computing device, at stylus and/or non-stylus touch inputs received at its touch surface with an input or step included in one of a plurality of workflows. In certain embodiments, the workflows can include one or more of an erasure, an undo operation, a redo or repeat operation, a brush size selection, a brush opacity selection, a selection of constraint, such as, but not limited to, a line angle constraint, a menu navigation, a menu node or menu item selection, a copy operation for a selected electronic asset, a cut operation for a selected electronic asset, and a paste operation for a previously cut or copied electronic asset.

In another embodiment, the touch computing device is configured to detect a second physical contact made by a second input means at the touch surface of the computing device, determine a pressure level corresponding to the second detected contact. The touch computing device can then receive first input and second inputs from the second input means and then associate, based at least in part on the second input from the second input means, the second input means with a second type of input means, the second type of input means being different from the first input means. In this way, exemplary embodiments can perform input differentiation for a stylus versus a non-stylus touch input means. In embodiments, inputs and workflows can comprise hybrid inputs including stylus and non-stylus inputs.

In an additional embodiment, as described below with reference to FIG. 19, the stylus can modulate its capacitive connection such that the stylus is suppressed or ‘not connected’ to a touch display until a sufficient pressure has been accumulated on the stylus tip. The precise timing between the stylus and touch application can prevent the tip contact from generating accidental touches that may not be identified by the touch application or a touch screen as being from a stylus.

In embodiments, input differentiation software executes on a touch computing device that is running a touch application. The input differentiation software runs as the touch computing device is receiving touch input on its touch surface and the touch computing device is also receiving a signal or indication from the stylus that indicates a certain amount of pressure presently being applied on the stylus tip. In one embodiment, the indication and the touch input are received nearly simultaneously. Based on the touch computing device receiving these two pieces of information, the touch computing device (or the touch application invoking the input differentiation software) determines that input is from the stylus and not from a finger or palm. In embodiments, a touch application receives input at the touch computing device and then determines whether or not that input should be associated with the stylus or is not associated with the stylus based on separate (i.e., non-touch and/or wireless) input received from the stylus relating to pressure. In other embodiments, a third type of input means, such as, for example, a non-capacitive touch stylus or a dumb stylus, may also be recognized and used for inputs and workflows in cases where the touch computing device has differentiated between a pressure sensitive stylus and a dumb stylus. In certain embodiments, this differentiation may be based on receiving a modulated pressure stream and/or a timestamp from the pressure sensitive stylus as compared to a dumb stylus that is unable to communicate a modulated pressure stream or a timestamp and a non-capacitive stylus that is unable to communicate a modulated pressure stream via its tip.

In embodiments, the exemplary inputs and workflows shown in FIGS. 4-18 are a set of interactions that can be enabled by having a software layer, such as such as components and/or modules developed using a software development kit (SDK) that provides distinction between touches from fingers and palm and contact from the stylus. According to embodiments, a software library or libraries can provide low-level support for a pressure sensitive stylus (such as, for example, the stylus 111 described with reference to FIGS. 1-3), and also provide a set of defined touch input and workflow functionality, such as, for example, the inputs and workflows shown in FIGS. 4-18.

As used herein, the term “pressure” refers to the effect of a mechanical force applied to a surface. Pressure can be quantified as the amount of force acting per unit area. That is, pressure is the ratio of force to the area over which that force is distributed. Pressure is force per unit area applied in a direction perpendicular to the surface of an object. In the context of touch computing devices, pressure can be measured as force per unit area applied in a direction substantially perpendicular or tangential to a touch surface of a touch computing device. In the context of a stylus used with touch computing devices, pressure can be measured as force per unit area applied in a direction substantially perpendicular or tangential to the elongate body of the stylus. For example, a level of pressure can be measured in terms of force per unit area applied to a stylus tip by a touch screen in response to the tip coming into contact with and being pressed onto the touch screen.

One exemplary embodiment includes an input device such as a stylus. The stylus is configured to interact with one or more touch computing devices and includes a capacitive tip at one end of the stylus, the tip being configured to interact with a touch surface of a computing device. The stylus is capable of detecting levels of pressure being applied via physical contact between the tip and a touch surface of a touch computing device. The stylus can communicate the detected pressure on a near-real-time basis to the touch computing device.

In embodiments, a stylus can measure levels or amounts of pressure applied at its tip. The stylus can produce many types of touch inputs and workflows based in part on having a pressure sensor for detecting and measuring pressure applied when the stylus tip is being pressed onto a touch surface, such as, for example, a capacitive touch surface.

Non-limiting examples of a pressure sensitive stylus incorporating a pressure sensor are described in commonly-assigned U.S. patent application Ser. No. ______ (Attorney Docket No. 58083/863896 (3076US01)), entitled “Pressure Sensor for Touch Input Devices,” by Dowd et al., which is incorporated by reference herein in its entirety.

In embodiments, a current pressure level and pressure status is determined and indicated. A threshold can also be determined as shown in FIG. 19. According to embodiments, this can comprise determining pressure statuses. For example, in addition to determining a pressure level from among thousands of potential pressure levels, statuses such as decreasing pressure, increasing pressure, static pressure (no change vis-à-vis a prior pressure level), relatively stable pressure (gradual ramp up or ramp down), and quiescent/no pressure. The determined status and pressure level can be communicated to a touch computing device from an input device. In one example a current pressure level and/or pressure status are communicated using a wireless transceiver in the input device to convey the pressure level information and/or pressure status to a touch application on a touch device receiving touch input from the input device.

In another embodiment, a stylus input includes a computer readable storage medium having logic encoded thereon, that when executed by a processor, causes the processor to determine and indicate, a number of pressure levels applied to a tip of the input device that is in contact with a surface, such as a touch surface of a touch computing device. In response to determining a pressure level, the logic can include instructions to indicate, via a wireless transceiver other suitable communications means, a pressure level, and a pressure status such as, but not limited to, increasing pressure, decreasing pressure, static pressure, and quiescence (i.e., a lack of pressure on the tip as would be the case when the tip is not in contact with a touch surface).

The logic can be encoded into circuitry such as one or more integrated circuits (ICs) on one or more printed circuit boards (PCBs). For example, the logic can be encoded in an application-specific IC (ASIC). The logic is executable by a processor, such as a microprocessor chip included in the circuitry on a PCB. When executed, the logic determines a pressure level and/or a pressure status.

As used herein, the term “input device” refers to any device usable to interact with an interface of a computing device. An input device may be one or more of a keyboard, a microphone, or a pointing/drawing device such as a mouse or stylus. Input devices can be configured to interact with a touch-sensitive interface of a computing device, such as a touch surface or a touch-sensitive display. As used herein, a “stylus” refers to any writing, drawing, or pointing instrument or utensil that is generally configured to be hand held and, in the context of touch screen computing devices, used to interact with a computing device having a touch-sensitive interface or touch surface (i.e., a touch computing device). The terms “input device” and “stylus” are used interchangeably herein to refer broadly and inclusively to any type of input device capable of interacting with a touch computing device.

As used herein, the term “computing device” refers to any computing or other electronic equipment that executes instructions and includes any type of processor-based equipment that operates an operating system or otherwise executes instructions. A computing device will typically include a processor that executes program instructions and may include external or internal components such as a mouse, a CD-ROM, DVD, a keyboard, a display, or other input or output equipment. Examples of computing devices are personal computers, digital assistants, personal digital assistants, mobile phones, smart phones, pagers, tablet computers, laptop computers, Internet appliances, other processor-based devices, gaming devices, and television viewing devices. A computing device can be used as special purpose computing device to provide specific functionality offered by its applications and by the interaction between their applications.

As used herein, the term “application” refers to any program instructions or other functional components that execute on a computing device. An application may reside in the memory of a device that executes the application. As is known to one of skill in the art, such applications may be resident in any suitable computer-readable medium and execute on any suitable processor. For example, as discussed below with reference to FIGS. 2 and 3 the stylus 111 can include a computer-readable medium as part of its circuitry 226A and 226B. The computer readable medium can be a memory coupled to a processor that executes computer-executable program instructions and/or accesses stored information. Such a processor may comprise a microprocessor, an ASIC, a state machine, or other processor, and can be any of a number of computer processors. Such processors include, or may be in communication with, a computer-readable medium which stores instructions that, when executed by the processor, cause the processor to perform the steps described herein.

These illustrative examples are given to introduce the reader to the general subject matter discussed here and are not intended to limit the scope of the disclosed concepts. The following sections describe various additional embodiments and examples with reference to the drawings in which like numerals indicate like elements. For brevity, only the differences occurring within the Figures, as compared to previous or subsequent ones of the figures, are described below.

### Exemplary Pressure Sensitive Stylus

Exemplary styli are described below with reference to FIGS. 1 and 2. FIGS. 1 and 2 include perspective views of a stylus input device configured to interact with a touch computing device. By incorporating a pressure sensitive tip and pressure sensor, such as the tip and pressure sensor described in U.S. patent application Ser. No. ______ (Attorney Docket No. 58083/863896 (3076US01)), entitled “Pressure Sensor for Touch Input Devices,” by Dowd et al., the stylus shown in FIGS. 1 and 2 can be configured to be a pressure sensitive stylus.

FIG. 1 shows a perspective view of a stylus 111 with a body 104 having a button 113. The body 104 is encased in a body housing 102 extending from the end of the stylus 111 having an indicator light 119 to a nozzle housing 103 at the other end. As shown in FIG. 1, the indicator light can be embodied as a light emitting diode (LED). In the embodiment shown in FIG. 1, the indicator light 119 is located at an end of the body 104 distal from the tip 109 so that it can remain visible to a user while the tip 109 of the stylus 111 is in contact with a touch surface of a touch computing device.

In cases where the stylus 111 is a stylus with an elongated body like the exemplary body 104, the body housing 102 will be an elongated housing configured to accept the body 104 and connect to the tip 109 through the nozzle housing 103 of the stylus.

In certain embodiments, the stylus 111 includes a wireless transceiver in the body 104. For example, a stylus 111 embodied as a multifunction stylus may include a Bluetooth transceiver (see, e.g., wireless transceiver 336 in FIG. 3), a wireless network transceiver, and/or some other wireless transceiver configured to transmit and receive communications, such as, but not limited to, pressure level indications and identifiers for electronic assets to be copied and pasted. In embodiments where the body 104 includes a wireless transceiver configured to receive and transmit data communications (i.e., via a Bluetooth or other wireless communications protocol), the indicator light 119 can indicate a communication status for any data communications between the stylus 111 and a touch computing device. In embodiments, the indicator light 119 is a multi-stage red, green, and blue (RGB) LED (i.e., a multi-color white LED).

As the exemplary stylus 111 is a pressure sensitive stylus, the tip 109 can be embodied as a pressure sensitive tip. Such a pressure sensitive tip 109 may be manufactured from a smooth and/or gentle material that is not harmful to a touch screen of a touch computing device. The pressure sensitive tip 109 can also be manufactured from a material that deforms when force is applied thereto. For example, the tip 109 may be manufactured from a synthetic or natural rubber material. Additionally, included within the stylus 111 may be a memory, a wireless transceiver, a processing unit, and/or other components (see, e.g., battery 208, button circuitry 226A, and main circuitry 226B in FIG. 2). These components within a stylus 111 may be distributed evenly such that the weight distribution of the stylus is balanced. In certain embodiments, the tip 109 and other components of such a stylus may be selected to provide capacitive capabilities for interacting with certain touch computing devices in addition to transferring some amount of pressure to internal pressure sensing components within the stylus 111. For example, in one embodiment, the tip 109 can comprise a material having an American Society for Testing and Materials (ASTM) technical standard D2240 Durometer Type A scale value of about 40 (i.e., a Durometer value of about Shore A 40). Non-limiting examples of such materials are synthetic rubber (i.e., a silicone rubber) and natural rubber.

FIG. 2 provides a perspective interior of the stylus 111. FIG. 2 is described with continued reference to the embodiment illustrated in FIG. 1. However, FIG. 2 is not limited to that embodiment. In particular, FIG. 2 depicts the body 104 with the body housing 102 removed. FIG. 2 shows that the stylus 111 includes the button circuitry 226A between the nozzle housing 103 and an internal battery 208. The stylus 111 can also include main circuitry 226B between the internal battery 208 and the indicator light 119. In certain embodiments, only one circuit board may be used to implement the functionality of the button circuitry 226A and the main circuitry 226B.

According to embodiments, the internal battery 208 supplies power to electrical components of the stylus 111, including the button circuitry 226A, a pressure sensor, the indicator light 119, and the main circuitry 226B.

Among other functionality, the button circuitry 226A is configured to provide the force levels measured by the pressure sensor. The button circuitry 226A may communicate or otherwise indicate measured levels of pressure via a wireless transceiver of the stylus 111. Alternatively, the button circuitry 226A can relay pressure levels, identifiers of assets to be copied and pasted, and other inputs via the main circuitry 226B, which in turn can communicate or convey the inputs.

In embodiments, the button circuitry 226A and/or the main circuitry 226B includes electronics and logic to indicate changes in pressure levels on the tip 109 to a touch application executing on a touch computing device. The indications can be communicated on a substantially real time basis. The button circuitry 226A and/or the main circuitry 226B can also include electronics and logic to communicate information uniquely identifying an electronic asset being copied or pasted using the stylus 111 to a touch application executing on a touch computing device. In one embodiment, logic is implemented as an integrated circuit (IC) within the button circuitry 226A. Changes in pressure applied to the tip 109 may be measured and quantified by the button circuitry 226A, which in turn can be communicated to the touch computing device the stylus 111 is currently interacting with. Similarly, other data needed for the stylus 111 to complete the exemplary inputs and workflows discussed below with reference to FIGS. 4-18 can be processed, at least in part, by one or both of the circuitry 226A and 226B, and then communicated to the touch computing device the stylus 111 is currently interacting with

In accordance with embodiments, the button circuitry 226A and the main circuitry 226B include a computer readable storage medium with executable instructions or logic for indicating a pressure level, timing information, workflow information, menu selections, copy/paste operations, and other inputs. The timing information can be communicated wirelessly via a wireless transceiver of the input device (see, e.g., the wireless transceiver 336 in FIG. 3). In embodiments, the timing information can include a timestamp based on an internal clock in the circuitry 226A or 226B. In one non-limiting embodiment, the stylus 111 is able to communicate timing information, such as clock synchronization information and/or a timestamp to a touch computing device within 37 milliseconds. This timing information can be used by the touch computing device to identify or differentiate an individual contact at a touch surface being from the tip 109 of the stylus 111 or from another source, such as a finger. The ability to transmit timing information quickly and to have a very fine time alignment or synchronization between the stylus 111 and a touch computing device allows the touch computing device to distinguish inputs from the stylus 111 versus other input means and devices (i.e., non-capacitive touch styli, fingers, palms, dumb styli) even in cases where the inputs begin within a tenth of a second with one another.

The circuitry 226A, 226B can comprise a printed circuit board (PCB) having one or more ICs or ASICs with logic encoded on them. The logic is executable by a processor, such as a microprocessor chip included in the circuitry 226A, 226B as part of the PCB. When executed, the logic determines a status, such as pressure threshold having been reached, a workflow having been initiated, or a workflow/input having been completed. Exemplary touch inputs and workflows are shown in FIGS. 4-18, and discussed below. As discussed below with reference to FIG. 19, determining that a pressure has been reached (or exceeded) can ensure that there is both sufficient pressure and sufficient contact in a contact area of the stylus 111 interacting with a touch surface. The circuitry 226A, 226B can then indicate the determined status along with a current level of pressure in near real time to a touch application the stylus 111 is currently providing input to.

Like a pairing operation between a stylus 111 and a touch computing device, in embodiments, indications of pressure levels, timing information, a pressure status, workflow inputs, menu selections, copy/paste operations, and other inputs can be performed by a combination of touch inputs and wireless communications.

Such data and information can be communicated via a wireless transceiver of the stylus 111. For example, a stylus 111 embodied as a multifunction stylus may include a wireless transceiver, such as a Bluetooth transceiver, a wireless network transceiver, and/or some other wireless transceiver for such communications.

### Exemplary System Implementation

FIG. 3 is a block diagram depicting example computing devices and systems for implementing certain embodiments. FIG. 3 is described with continued reference to the embodiment illustrated in FIGS. 1 and 2. However, FIG. 3 is not limited to that embodiment. The example computing systems include a server system 302. The exemplary computing devices include computing devices 304a, 304b in communication via a data network 306.

The server system 302 includes a processor 305. The processor 305 may include a microprocessor, an application-specific integrated circuit (ASIC), a state machine, or other suitable processing device. The processor 305 can include any number of computer processing devices, including one. The processor 305 can be communicatively coupled to a computer-readable medium, such as a memory 308. The processor 305 can execute computer-executable program instructions and/or accesses information stored in the memory 308. The memory 308 can store instructions that, when executed by the processor 305, cause the processor to perform operations described herein.

A computer-readable medium may include, but is not limited to, an electronic, optical, magnetic, or other storage device capable of providing a processor (see, e.g., processors 318a, 318b, 305, and 330 in FIG. 3 and processor 2004 of FIG. 20) with computer-readable instructions. Other examples include, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may include processor-specific logic or instructions generated by a compiler and/or an interpreter from code written in any suitable computer-programming language, including, for example, C, C++, C#, Visual Basic, Java, Python, Perl, JavaScript, and ActionScript.

The server system 302 may also include a number of external or internal devices, such as input or output devices. For example, the server system 302 is shown with an input/output (I/O) interface 312. A bus 310 can also be included in the server system 302. The bus 310 can communicatively couple one or more components of the server system 302. In the non-limiting example of FIG. 3, the server system 302 can be embodied as a cloud server hosting a cloud application 316.

Each of the computing devices 304a, 304b includes respective processors 318a, 318b. Each of the processors 318a, 318b may include a microprocessor, an ASIC, a state machine, or other processor. In the non-limiting example of FIG. 3, the computing devices 304a, 304b can be embodied as touch computing devices such as the exemplary touch computing devices shown in FIGS. 6-18. Each of the computing devices 304a, 304b can include respective clocks, as part of their processors 318a, 318b, or elsewhere. Each of the processors 318a, 318b can include any of a number of computer processing devices, including one. Such a processor can include or may be in communication with a computer-readable medium. Each of the processors 318a, 318b is communicatively coupled to respective memories 320a, 320b. Each of the processors 318a, 318b respectively executes computer-executable program instructions and/or accesses information stored in the memories 320a, 320b. The memories 320a, 320b store instructions that, when executed by the processor, cause the processor to perform one or more operations described herein.

The computing devices 304a, 304b may also comprise a number of external or internal devices such as a mouse, a CD-ROM, DVD, a keyboard, a display, audio speakers, one or more microphones, or any other input or output devices. For example, each of the computing devices 304a, 304b is respectively shown with I/O interfaces 324a, 324b and display devices 326a, 326b. A non-limiting example of a display device is a computer monitor or computer screen, such as a touch screen. In the non-limiting example of FIG. 3, the display devices 326a, 326b can be embodied as touch display devices. Although FIG. 3 depicts the display devices 326a, 326b as separate devices coupled to the computing devices 304a, 304b, the display devices 326a, 326b can be respectively integrated into the computing devices 304a, 304b.

Buses 322a, 322b can be respectively included in the computing devices 304a, 304b. Each of the buses 322a, 322b can communicatively couple one or more components of the computing devices 304a, 304b.

FIG. 3 also illustrates the cloud application 316 comprised in the memory 308 of the server system 302 and the client applications 328a, 328b respectively comprised in the memories 320a, 320b of the computing devices 304a, 304b. The cloud application 316 stored in the memory 308 can configure the processor 305 to manage and provide a cloud service accessible by the client applications 328a, 328b. In the non-limiting example of FIG. 3, the memory 308 can function as cloud storage. In alternative embodiments, cloud storage can be implemented as a separate cloud storage device. The cloud storage device can be implemented as one or more file servers, one or more database servers, and/or one or more web servers that form part of the server system 302. The cloud application 316 can include one or more modules for storing, modifying, providing, or otherwise using assets in a cloud service accessed by the client applications 328a, 328b. The cloud storage device can be implemented as a virtual, network-accessible storage device used by the cloud application 316 to store, modify, and provide assets in a server-based clipboard service accessed by the client applications 328a, 328b. The cloud application 316 can store and provide electronic assets in order to provide a server-based (i.e., cloud-based) clipboard. A non-limiting example of a cloud application 316 is the Adobe® Creative Cloud server software.

Each of the client applications 328a, 328b can include one or more software modules for establishing communication with a cloud application 316. Each of the client applications 328a, 328b can also include one or more software modules for performing functions in addition to establishing communication with the cloud application 316. For example, each of the client application 328a, 328b can be an image manipulation application having a software module for communicating with the cloud application 316. In some embodiments, each of the client application 328a, 328b can be a different type of application including different functionality. For example, a client application 328a can be Adobe® Ideas® and a client application 328b can be Adobe® Illustrator®. In some embodiments, the client applications 328a, 328b can be stand-alone applications. In other embodiments, the client applications 328a, 328b can be embedded in another application, such as an image manipulation application.

The server system 302 can include any suitable server or computing device for hosting the cloud application 316. In one embodiment, the server system 302 may be a single server, such as a web or application server. In another embodiment, the server system 302 may be presented as virtual server implemented using a number of server systems connected in a grid or cloud computing topology.

The computing devices 304a, 304b can include any suitable computing device or system for communicating via a data network 306 and executing the client applications 328a, 328b. Non-limiting examples of a suitable computing device or system include a desktop computer, a tablet computer, a smart phone, or any other computing device or system suitable for using electronic content.

An input device (a stylus 111 in the example of FIG. 3) can include a processor 330 and a storage medium or memory 332. In the non-limiting example of FIG. 3, the input device can be embodied as a stylus. The processor 330 can execute instructions stored in the memory 332. The stylus 111 can include an internal clock, as part of its processor 330, or elsewhere (i.e., in the circuitry 226A, 226B of FIG. 2). The memory 332 can include an I/O module 334. The I/O module 334 can establish communications with one or more of the computing devices 304a, 304b. The stylus 111 can communicate with the computing devices 304a, 304b over the data network 306 or another wireless network, such as a Bluetooth network, via a wireless transceiver 336 or other suitable communication device. In one embodiment, the wireless transceiver is a wireless network transceiver configured to communicate using a Bluetooth protocol (i.e., a Bluetooth transceiver).

According to embodiments, timing information such as a timestamp and pressure level information can be transmitted from the stylus 111 to a computing device 304a or a client application 328a that the stylus is interacting with. In embodiments, this information can be used by the client application, e.g., 328a, executing on the computing device 304a, to identify touch inputs received via an associated touch display devices 326 as being from the stylus 111 as opposed to other input means, such as fingers. In certain embodiments, the timing information can comprise two components or levels. The first level can be based upon a known time delay between sending a signal or data wirelessly from the pen and it reaching the client application 328a. For example, after a first touch input by the stylus 111 tip 109 at the display device 326a, the client application 328a can identify that touch input as being from the stylus 111 based on receiving a second, wireless input from the stylus 111 within a threshold time span of a time that the touch input was received. Another level can be synchronizing clocks between the stylus 111 and the computing device 304a. Through clock synchronization, a degree of uncertainty or period of time in which a contact or input received at a touch display device 326a cannot be identified as being from a stylus 111 or another input means can be reduced to a matter of milliseconds. By way of example, after a first touch input by the stylus 111 at the display device 326a, the client application 328a can identify that touch input as being from the stylus 111 based on receiving a second input from the stylus 111 identifying synchronization between a clock of the computing device and a clock of the stylus.

In an additional or alternative embodiment, locality of a touch input on touch surface such as the touch display device 326a can be used to differentiate between input from the stylus 111 and other input means. Such locality can be used by the client application 328a or the computing device 304a the client application 328a is executing on, to process ambiguous touch inputs. For example, if a user selects one point in the touch display device 326a with their finger while selecting a second point with the stylus 111 and then, within a fraction of a second, puts the stylus 111 tip 109 down where the finger was and the finger where tip 109 was, locality information and the contact are of at the respective points can be used that to ensure that the stylus 111 contacts/inputs and the finger contacts remain differentiated from each other and unambiguous. Combined with, or in addition to pressure level and timing information, location of a contact on the display device 326a can be used to distinguish inputs in cases where multiple inputs from multiple input means are intermixed at the same time based on determining that the finger inputs are going to typically be on one part of the touch display device 326a and the stylus 111 tip 109 is going to be in another part of the display device 326a.

A non-limiting example of a stylus 111 is stylus 111 shown in FIGS. 1 and 2, or other device configured to provide a touch input or other input to computing devices 304a, 304b. In certain embodiments, the stylus 111 is a multifunctional stylus having the storage medium or memory 332 and a wireless transceiver 336 in its body 104. In other embodiments, the multifunctional stylus 111 also includes a physical button (see, e.g., button 113 in FIG. 1) and a light emitting diode (LED) such as the indicator light 119 shown in FIG. 1. Non-limiting examples of such styli are described in more detail in U.S. patent application Ser. No. 33/572,231 entitled “Multifunctional Stylus”, filed Aug. 30, 2012, which is incorporated by reference herein in its entirety.

In some embodiments, the memory 332 and I/O module 334 can be implemented as firmware. As used herein, the term “firmware” is used to refer to one or more operating instructions for controlling one or more hardware components of a device. Firmware can include software embedded on a hardware device. A firmware module or program can communicate directly with a hardware component, such as the processor 330 of the stylus 111, without interacting with the hardware component via an operating system of the hardware device.

### Exemplary Touch Inputs

FIG. 4 depicts the forms of input that may be indicated via a stylus, one or more fingers, or both a stylus and one or more fingers. FIG. 4 is described with continued reference to the embodiments illustrated in FIGS. 1-3. However, FIG. 4 is not limited to those embodiments. In particular, FIG. 4 provides forms of inputs 400 that the stylus 111 may provide to a client application 328a, 328b via interaction with a display device 326a, 326b. As shown in FIG. 4, some of the inputs 400 can be provided in part by tapping the tip 109 of the stylus 111 against a touch display 326a of a touch computing device 304a. A single tap against the touch display 326a of a touch computing device 304a may cause one or more actions to be performed by a client application 328a being implemented by the touch computing device 304a. Similarly, the stylus 111 may be used to indicate other forms of input 400 such as a long press of the tip 109 of the stylus 111 against the touch screen and a double tap of the tip 109 of the stylus 111 against the touch screen. The stylus 111 may also be used to indicate an input 400 based on an amount of pressure applied by a user. For instance, the stylus 111 may measure the pressure applied by the user and transmit an input via the wireless transceiver 336 based on the amount of pressure applied. Additionally, as shown in FIG. 4, other forms of input 400 include dragging the tip 109 against the touch screen and flicking the tip 109 against the touch display 326a. Further, a selection may be drawn by outlining a desired selection with the tip 109. Still further, FIG. 4 shows that the inputs 400 can include two finger inputs such as pinching, two-finger tapping, and three-finger tapping.

In embodiments, the touch computing device 304a and/or the client application 328a is able to perform input differentiation, based at least in part on pressure and contact area, in order to differentiate between touch inputs 400 by the stylus 111 and inputs using fingers, palms, or other input means.

In certain embodiments, the capacitive difference of a finger or palm input as compared to a stylus 111 input can be used. In alternative or additional embodiments, the timing of pressure applied is used to differentiate stylus 111 inputs 400 as compared to finger touch inputs they are emulating. These embodiments can use a pressure sensor in the stylus 111, together with a timestamp or other timing data sent via the wireless transceiver 336 (i.e., a Bluetooth transceiver), to distinguish between contact from the stylus 111 versus fingers or a palm. Embodiments involve toggling capacitive differentiation versus timing to differentiate inputs from a tip 109 versus a finger or palm.

In another embodiment, the stylus button 113 that may be depressed and/or clicked to indicate another form of input, such as initiation of a copy or paste operation for an electronic asset. For example, as shown in FIG. 1, the button 113 may be a physical button displaced on the exterior of the stylus 111 (i.e., on the body 104). In one embodiment, the button may be located on one end of the body 104, such as the near the tip 109.

### Exemplary Touch Modifications, Menu Interactions, and Inputs/Operations

FIG. 5 depicts exemplary touch inputs 500 for modifications, menu interactions, and other touch interactions capable of being input by a touch input device and capable of being recognized and processed by touch based computing device.

FIG. 5 depicts forms of input that may be provided using a stylus, either alone, or in combination with another input means, such as for example, a finger or a palm. FIG. 5 is described with continued reference to the embodiments illustrated in FIGS. 1-3. However, FIG. 5 is not limited to those embodiments. In particular, FIG. 5 provides forms of inputs 500 that the stylus 111, alone, or in conjunction with another input means, may provide to a client application 328a, 328b via interaction with a display device 326a, 326b. As shown in FIG. 5, some of the inputs 500 include modification inputs 510, menu inputs 520, and additional inputs 530.

As shown in FIG. 5, the modification inputs 510 can include touch inputs to modify a canvas, workspace, or electronic asset. The modification inputs can include the exemplary erase, undo, and redo modifications shown in FIG. 5. The modification inputs 510 can serve to erase, undo, and redo (or re-apply) previously supplied inputs, operations, and commands. As shown in FIG. 6, the erase input may be provided in part by swiping over a portion of a previously created object in a canvas 602 with a finger. With continued reference to FIG. 5, the modification inputs 510 can further include modifications to a brush size and opacity in a drawing, graphics, or sketching application. The modification inputs 510 can also include modifications to previously established or default constraints, such as constraints for line angles in a touch application (see, e.g., FIG. 9).

FIG. 5 also shows that the menu inputs 520 can include touch-based inputs to interact with a menu and select menu nodes or options. The menu inputs 520 can include inputs and selections in color menus (i.e., to select a color from a color palette, such as the exemplary color menu shown in FIGS. 13-16), an eyedropper menu or node such as the eyedropper node shown in FIG. 13, and a brush menu, such as the brush/pencil tip node shown in FIG. 13. The menu inputs 520 can also include the exemplary clipboard and scratchpad menus shown in FIG. 5. In an embodiment, menu inputs 520 into a clipboard menu can be used to perform clipboard-based copy and paste operations such as the exemplary copy and paste workflows shown in FIGS. 17 and 18.

Lastly, FIG. 5 shows that the additional inputs and operations 530 can include touch-based inputs for palm rejection and inputs to perform copy and paste operations, such as, for example, those shown in FIGS. 17 and 18. As shown in FIG. 5, the additional inputs and operations 530 can also a double click of the button 113 of the stylus 111 to disconnect the stylus 111. This can disconnect a stylus 111 that was previously paired with and/or recognized by a touch computing device 304a or a client application 328a running on the computing device 304a.

The modification inputs 510, menu inputs 520, and additional inputs/operations 530 shown in FIG. 5 are merely exemplary. Further context-specific modification inputs 510, menu inputs 520, and additional inputs and operations 530 can be implemented using various sequences of the inputs 400 shown in FIG. 4 combined with other inputs as part of defined workflows. Exemplary workflows are discussed below with reference to FIGS. 6-18. Also, the modification inputs 510, menu inputs 520, and additional inputs 530 shown in FIG. 5 can be provided via one or more of the inputs 400 described above with reference to FIG. 4 and as part of the workflows and operations shown in FIGS. 6-18. According to embodiments, the touch computing device 304a and/or the client application 328a is able to perform input differentiation, based at least in part on pressure and contact area differences between two or more input means (i.e., a stylus 111 and a finger input 611 as shown in FIGS. 6, 10, and 11), in order to differentiate between touch inputs 500 by the stylus 111 and inputs using fingers, palms, or other input means. In another embodiment, the stylus button 113 may be depressed and/or clicked to indicate another form of input, such as initiation of a copy or paste operation for an electronic asset.

### Exemplary Workflows

FIGS. 6-18 illustrate exemplary workflows implemented using a stylus and touch sensitive user interfaces (UIs), according to embodiments of the present disclosure. The workflows and UIs depicted in FIGS. 6-18 are described with reference to the embodiments of FIGS. 1-5. However, the workflows and UIs are not limited to those example embodiments. In an embodiment of the invention, the interfaces for client applications 328a and 328b illustrated in FIGS. 6-18 are displayed on mobile computing devices 304a and 304b, which each have a respective touch sensitive (i.e., touch screen) display device, namely 326a and 326b. For ease of explanation and illustration, the workflows, menu inputs, and operations discussed below and shown in FIGS. 6-16 are in the context of a client application 328a executing on a tablet computing device 304a with a touch-screen display device 326a, and the paste operations shown in FIGS. 17 and 18 are discussed in the context of destination client applications 328a and 328b executing on a table computing device 304a and a smartphone computing device 304b, respectively. However, the workflows and operations are not intended to be limited to the exemplary devices and platforms shown in FIGS. 6-18. Non-limiting examples of operating systems and platforms having touch sensitive surfaces and screens include tablets and smartphones and running the iOS from Apple, Inc., the WINDOWS® Mobile OS from the MICROSOFT™ Corporation, the Windows® 8 OS from the MICROSOFT™ Corporation, the Android OS from Google Inc., the Blackberry® OS from Research In Motion (RIM), and the Symbian OS. It is to be understood that the workflows and UIs illustrated in the exemplary embodiments of FIGS. 6-18 can be readily adapted to execute on displays of a variety of mobile device platforms running a variety of operating systems that support a touch interface.

Throughout FIGS. 6-18, input devices and displays are shown with various icons, command regions, windows, toolbars, canvases menus, tiles, and buttons that are used to initiate actions, invoke routines, perform workflows, copy electronic assets, paste electronic assets, or invoke other functionality. The initiated actions include, but are not limited to, erasing (FIG. 6), undoing (FIG. 7), redoing (FIG. 8), constraining (FIG. 9), changing a brush size (FIG. 10), changing a brush opacity (FIG. 11), invoking/displaying a menu (FIG. 12), interacting with a menu (FIGS. 13-16), selecting an electronic asset to be copied to a clipboard (FIG. 17), selecting a target location to paste an asset FIG. 18), and other workflows, inputs, and gestures. For brevity, only the differences occurring within the figures, as compared to previous or subsequent ones of the figures, are described below.

In embodiments, the exemplary inputs and workflows shown in FIGS. 4-18 are a set of interactions that can be enabled by having a software layer, such as components and/or modules developed using a software development kit (SDK), that provides distinction between touches from non-stylus means (see, e.g., finger input means 611 in FIGS. 6, 10, and 11) and contact from the stylus 111. Another exemplary non-stylus touch input includes and palm inputs, such as a palm cancel or palm wipe (i.e., wiping a palm in a cardinal direction). An example of a finger input from inputs 400 shown in FIG. 4 is a wipe in a cardinal direction with a finger input means 611, as shown in FIG. 6

In embodiments, the display devices 326a and 326b used to display the user interfaces shown in FIGS. 6-18 may be displayed via the display interface 2002 and the computer display 2030 described below with reference to FIG. 20. According to embodiments, a user can interact with touch screen displays 326a and 326b using the exemplary stylus 111 shown in FIGS. 6-18. However, alternative and additional input devices can be used, such as a different stylus (i.e., a non-capacitive stylus or touch stylus), a finger (see, e.g., finger input means 611 in FIGS. 6, 10, and 11), a physical button on the computing device (see, e.g., buttons 613 in FIGS. 6-18), a mouse, a keyboard, a keypad, a joy stick, a voice activated control system, or other input devices used to provide interaction between a user and client applications 328a and 328b. As described below with reference to FIGS. 6-18, such interaction can be used to perform workflows and operations using the exemplary inputs and operations shown in FIGS. 4 and 5.

As shown in user interfaces and canvases 602 in FIGS. 6-18, a user may provide one of a variety of touch inputs, such as, but not limited to the inputs 400 and 500 shown in FIGS. 4 and 5, by manipulating the stylus 111 and/or another input means (see, e.g., finger inputs 611 in FIGS. 6 and 10) against the touch screens 326a and 326b of the touch computing devices 304a and 304b. In one embodiment, the user may click the button 113 on the stylus 111 to provide an input. In certain embodiments, a physical button 613 on the touch computing device 304a can be used in conjunction with touch inputs provided to the touch screen 326a. In another embodiment, the user may tap the touch screen 326a with the tip 109 of the stylus 111, drag the stylus 111 against the touch screen 326a, provide other inputs as discussed above with reference to FIGS. 4 and 5, and/or provide various sub combinations and sequences of the inputs (i.e., workflows).

FIG. 6 illustrates an erase input sequence. In particular, FIG. 6 shows a workflow comprising a first input 620 of a drawing operation by a stylus 111 in a touch display device 326a of a client application 328a. The client application is executing on a touch computing device 304a. The first input 620 is in a canvas 602 (or presentation) currently displayed by the client application 328a. As shown, the first input 620 is followed by a second input 622 comprising an erase input using a second input means 611 as shown in FIG. 6. In another embodiment, the second input 622 can be a swipe in a cardinal direction with a finger input means 611 (i.e., a finger erase using a swipe input in a cardinal direction (see inputs 400 in FIG. 4)). In the example of FIG. 6, the swipe input is not in a cardinal direction, and thus can be conceptualized as a stroke input or single finger stylus input.

In embodiments, the client application 328a is able to differentiate between input received via the stylus 111 and the finger means 611 based on the capacitive difference between the stylus tip 109 and the finger means 611. In alternative embodiments, the input differentiation is additionally or alternatively achieved by comparing timing between the computing device's 304a touch information and pressure information retrieved by the stylus 111. This is useful in cases where capacitive difference information is not available to the client application 328a, i.e., due to platform features of the computing device 304a, such as, but not limited to, its operating system (OS) and characteristics of its touch screen 326a. The computing device 304a itself, depending on the platform and/or OS, may not deliver any pressure information to the client application 328a. In these cases, embodiments use the stylus 111 to provide that information. In certain embodiments, the stylus 111 functions as a pressure sensor that sends pressure information to the client application 328b via the wireless transceiver 336 of the stylus 111 (i.e., via a Bluetooth transmitter). The exemplary stylus 111 can do this very quickly (in near real time—in the range of 37 milliseconds in one embodiment) so that the timing of the stylus 111 is closely aligned with that of the computing device 304a. In an embodiment, this same timing information can then also be used to distinguish between contact from the stylus 111 and contact from finger input means 611. Additionally, as described below with reference to the example embodiment shown in FIG. 19, the stylus 111 can modulate its capacitive connection such that the stylus 111 is suppressed or ‘not connected’ to the touch display 326a until a sufficient pressure has been accumulated on the tip 109. The precise timing between the stylus 111 and application 328a prevents the tip 109 contact from generating accidental touches that may not be identified by the application 328a or touch screen 326a as being from the stylus 111.

From the perspective of the computing device 304a running the application 328a, the computing device 304a is receiving touch input on the touch surface 326a and the computing device 304a is receiving a signal from the stylus 111 that indicates a certain amount of pressure presently being applied on the tip 109. Based on the computing device 304a receiving these two pieces of information, the computing device 304a (or the client application 328a) determines that input, such as the first input 620 is from the stylus and not from the finger input means 611. In embodiments, a client application 328a receives input at the touch device 304a and then determines whether or not that input should be associated with the stylus 111 or is not associated with the stylus 111 based on separate (i.e., non-touch or wireless) input received from the stylus 111 relating to pressure and/or based on whether separate input is received from the stylus or not received from the stylus.

FIG. 7 illustrates an undo input sequence. In particular, FIG. 7 shows a workflow comprising a first input 720 of drawing successive marks by a stylus 111 in a touch display device 326a of a client application 328a. The first input 720 is in a canvas 602 (or presentation) currently displayed by the client application 328a. As shown, the first input 720 is followed by a second input 722 comprising an undo input using the stylus 111 (i.e., an undo using a tap, see inputs 400 in FIG. 4). The second input 722 can be a tap with a stylus 111 as shown in FIG. 7. Alternatively, the second input 722 may be a tap with a finger input means 611 in cases where the computing device 304a has already differentiated between the stylus 111 that is in contact with the display device 326a and a finger input means 611 that is also in contact with the display device 326a.

FIG. 8 illustrates a redo input sequence. In particular, FIG. 8 shows a workflow comprising a first input 820 of a drawing a first mark using a stylus 111 in a touch display device 326a. The first input 820 is in a canvas 602 displayed by the client application 328a. As shown, the first input 820 is followed by a second input 822 comprising a redo (or repeat) input using the stylus 111. In the non-limiting example of FIG. 8, the redo is accomplished in using a two-finger tap as the second input 822 (see inputs 400 in FIG. 4). The second input 822 can be a two-finger tap emulated by the stylus 111 as shown in FIG. 8. Alternatively, the second input 822 may be a two-finger tap with a finger input means 611 in cases where the computing device 304a has already differentiated between the stylus 111 being used to provide input via the display device 326a and a finger input means 611 that is also in contact with the display device 326a.

FIG. 9 illustrates a constraint sequence. In particular, FIG. 9 shows a workflow for constraining angles in a canvas 602. As shown, a first input 920 constrains a line angle with two a two finger long press, then drawing a vertical line with the stylus 111 in the touch display device 326a. As shown, the first input 920 is followed by a second input 922 comprising an input to further constrain the line angle with two finger long press, then drawing in a downward angle using the stylus 111 (i.e., a constrain workflow using a two-finger long press as shown in FIG. 4). In an embodiment, the first and second inputs 920 and 922 can include a two-finger long press emulated by the stylus 111 as shown in FIG. 9. Alternatively, one or both of the two-finger long press inputs in inputs 920 and 922 can be provided using a finger input means 611 in cases where the computing device 304a has differentiated between the stylus 111 and a finger input means 611.

FIGS. 10 and 11 illustrate exemplary workflows for changing a brush size and a brush opacity, respectively. In particular, FIG. 10 shows a workflow for changing a brush size in a canvas 602. As shown in FIG. 10, a first input 1020 comprising a long finger press, which invokes a bi-directional brush size and opacity heads-up display (HUD) with finger input means 611 in the touch display device 326a. As shown, the first input 1020 is followed by a second input 1022 comprising swiping vertically with the finger input means 611 to change a brush size (i.e., a change brush size workflow using long finger press and swipe input as shown in FIG. 4). In an embodiment, the long finger press and swipe of the first and second inputs 1020 and 1022, respectively, can be emulated by the stylus 111. Alternatively, one or both of the long finger press and swipe for inputs 1020 and 1022, respectively can be provided using a finger input means 611 in cases where the computing device 304a has differentiated between the stylus 111 and a finger input means 611 as shown in FIG. 10. FIG. 11 shows an exemplary workflow for changing a brush opacity. As shown in FIG. 11, a first input 1120 comprising a long finger press, which invokes a bi-directional brush size and opacity HUD with finger input means 611 in the touch display device 326a. FIG. 11 shows that the first input 1120 is followed by a second input 1122 comprising a swiping horizontally with the finger input means 611 to change a brush opacity (i.e., a change brush opacity workflow using long finger press and swipe inputs as shown in FIG. 4). In an embodiment, the long finger press and swipe of the first and second inputs 1120 and 1122, respectively, can be emulated by the stylus 111. Alternatively, one or both of the long finger press and swipe for inputs 1120 and 1122, respectively can be provided using a finger input means 611 in cases where the computing device 304a has differentiated between the stylus 111 and a finger input means 611 and recognizes long finger press and swipe inputs from both the stylus 111 and the finger input means 611 as shown in FIG. 11.

FIG. 12 shows a workflow for invoking/displaying a menu. As shown in FIG. 12, a first input 1220 comprising a single click on the button 113 of the stylus 111, which invokes a pen tip menu 1224, which is displayed on touch display device 326a. In the non-limiting embodiment shown in FIG. 12, the pen tip menu 1224 includes three selectable nodes for a color menu, an eyedropper menu (the pencil tip icon in the pen tip menu 1224), and a brushes menu (pencil tip icon in FIG. 12) corresponding to the color, eyedropper, and brushes menu inputs 520 shown in FIG. 5.

FIGS. 13-15 illustrate exemplary workflows for interacting with nodes of the pen tip menu 1224 shown in FIG. 12. In particular, FIG. 13 shows that a first input 1320 of tapping on the color node of the pen tip menu 1224 invokes a sub menu, in this case, color menu 1324. As shown, the color menu 1324 is an expansion of the selected color node and can be embodied as a color palette for a client application 328a. In an embodiment, the tap of the first input 1320 can be input via the stylus 111 tip 109, as shown in FIG. 13. Alternatively, the tap of the first input 1320 can be input via provided using a finger input means 611 in cases where the computing device 304a has differentiated between the stylus 111 and a finger input means 611 and is currently recognizing a tap input from both the stylus 111 and the finger input means 611. FIG. 14 shows that tap input 1420 in a selection (i.e., a color) within the color menu 1324, results in selection of that color and dismissal of the pen tip menu 1224. As shown in FIG. 14, after receiving the selection input 1420, the resulting interface 1424 no longer displays the pen tip menu 1224. FIG. 15 shows that if an input 1520 of a tap is received outside of the pen tip menu 1224 or a submenu, such as, for example the color menu 1324, the menu (or submenu) is dismissed and the interface 1524 is presented on the display device 326a without the previously displayed menu. According to an embodiment, the tap of the first input 1520 can be input via the tip 109, as shown in FIG. 15. Additionally, the tap of the first input 1520 can be input via provided using a finger input means 611 if the computing device 304a (or a client application 328a presenting the color menu 1324) has differentiated between the stylus 111 and a finger input means 611 and is configured to recognize tap inputs from both the stylus 111 and the finger input means 611.

FIG. 16 shows that in alternative embodiments, more selectable nodes of submenus can be included in an exemplary context-aware pen tip menu 1624. In embodiments, the context-aware pen tip menu 1624 is invoked by a first input 1620 comprising a single click of the button 113, includes selectable nodes based on current context of a client application 328a that the context-aware pen tip menu 1624 is invoked from, the context of the stylus 111, and/or the context of the computing device 304a where the client application 328a is executing.

### Exemplary Copy and Paste Workflows

FIGS. 17 and 18 provide exemplary workflows for copy (or cut) and paste operations using the stylus 111. By performing the workflows in FIGS. 17 and 18, a user can indicate an asset to be copied to a clipboard to select a target location where an asset is to be pasted.

A server-based clipboard can enable an image or other asset copied from a first device having a screen with a given size and/or dimensions, such as a smart phone, to be skewed, scaled, or otherwise modified for display on a second, destination device having a screen with a different size and/or dimensions, such as a tablet computer or desktop computer. In embodiments, such processing for the clipboard can be performed on the server system, thereby providing for faster performance than non-server based clipboard applications, such as local clipboard applications on touch computing devices. In an embodiment, a server-based clipboard can be provided by the server system 302 or its cloud application 316 shown in FIG. 3.

As used herein, the term “electronic content” is used to refer to any type of media that can be rendered for display or use at a computing device such as a touch computing device or another electronic device. Electronic content can include text or multimedia files, such as images, video, audio, or any combination thereof. Electronic content can also include application software that is designed to perform one or more specific tasks at a computing device.

As used herein, the terms “asset” and “electronic asset” are used to refer to an item of electronic content included in a multimedia object, such as text, images, videos, or audio files.

As used herein, the term “clipboard” is used to refer to a location in a memory device accessible via multiple applications that provides short-term data storage and/or data transfer among documents or applications. Data transfer between documents and applications can be performed via interface commands for transferring data such as cutting, copying, and/or pasting operations. For example, a clipboard can provide a temporary data buffer that can be accessed from most or all programs within a runtime environment. In some embodiments, a clipboard can allow a single set of data to be copied and pasted between documents or applications. Each cut or copy operation performed on a given set of data may overwrite a previous set of data stored on the clipboard. In other embodiments, a clipboard can allow multiple sets of data to be copied to the clipboard without overwriting one another.

FIGS. 17 and 18 illustrate how an exemplary input device 111 having a tip 109, a button 113, and an indicator light 119 can be used to interact with display device 326a of a tablet computing device 304a to copy a selected asset 1704 to clipboard so that the copied asset 1704 is available for a subsequent paste operation at a different computing device 304b. FIG. 18 shows how a copied asset 1704 can be pasted into a presentation output of a different client application (i.e., cross-application) on a different computing device (i.e., cross-device).

As an example, the user may desire to copy the image presented in a user interface of a client application 328a. To this end, the user may provide input that corresponds with copying the image (such as, pressing the button 113 and subsequently tapping an image or other electronic asset 1704 with the tip 109 of the stylus 111). In response, the application 328a may copy the selected electronic asset 1704 and provide a reference or unique identifier for the asset 1704 to the stylus 111. For example, the stylus 111 may transmit a request to receive the copied image to the touch computing device 304b via the wireless transceiver 336. In response, the touch computing device 304a may transmit the copied image to the stylus 111 over the data network 306. In one embodiment, the stylus 111 may store a reference to a storage location for the asset 1704 in memory 332 of the stylus 111 where the reference is to a storage location in the server system 302. Additionally, the indicator light 119 of the stylus 111 may be lit a certain color to indicate that data is being received by the stylus 111, that data is being stored by the stylus 111, and/or indicate some other status.

FIGS. 17 and 18 illustrate exemplary user interfaces and workflows for copying and pasting operations. In particular, FIG. 17 shows a copy workflow comprising inputs 1702-1706 and an indicating or output step 1708. Although described with reference to a copy operation, the workflow shown in FIG. 17 is applicable to a cut operation as well. As shown, an input 1702 can initiate a copy sequence at the source computing device 304a. The exemplary input 1702 is a ‘long press’ on the stylus button 113 while the stylus is in the air (i.e., pressing the button 113 and holding it down while the stylus tip 109 is not in contact with the display device 326a and/or the client application 328a). Next, an input 1703 performs a copy operation. As shown in FIG. 17, the input 1703 comprises placing the stylus tip 109 on an asset 1704 in a canvas with a long press gesture and then releasing the button 113 while the stylus tip 109 is still in contact with the canvas 602 (i.e., the presentation output of the client application 328a on the display device 326a). In one non-limiting embodiment, an input 1703 with a long press gesture of about 2 seconds will cause the client application 328a to perform a copy operation.

Next, input 1706 results in the asset 1704 being copied to a server-based clipboard available through, for example, the cloud application 316 or another application on the server system 302. In the example embodiment of FIG. 17, the input 1706 is a finger release from the stylus button 113. FIG. 17 illustrates an embodiment in the context of copying an asset 1704 that is part of layer content (i.e., a layer of the canvas 602 or a presentation). In this context, in response to input 1706 for an asset 1704 that is layer content, an animation can be displayed by the client application 328a to give a user the impression that the copied asset 1704 is being vacuumed into the stylus tip 109. Such an animation can serve to cognitively reinforce the copy action by providing a visual indication within the canvas 602 that the selected asset 1704 has been cut or copied.

After the copy action has been performed as a result of inputs 1702-1406, a confirmation output 1708 can be provided to notify a user that with that the copied asset 1704 is available to be subsequently placed or pasted. The output 1708 can be displayed on the display device 326a by the client application 328a and/or by the stylus input device 111. The output 1708 confirms that the copied asset 1704 is available to be placed or pasted within the same client application 328a, a new destination application 328b, and/or another touch computing device 304b. In the example provided in FIG. 17, the indication 1708 is embodied as the stylus indicator light 119 being momentarily illuminated to convey to the user that the selected asset 1704 has been copied to a clipboard and that the stylus input device 111 is now ‘loaded’ with a storage location reference or unique identifier of the copied asset 1704. In embodiments involving multiple client applications 328a, 328b and/or multiple computing devices 304a, 304b, the clipboard can be a server-based clipboard, provided by, for example, the cloud application 316 or another application on the server system 302. In embodiments, the indication 1708 can comprise illuminating a green indicator light 119 and then blinking the indicator light 119 twice.

FIG. 18 shows an exemplary paste workflow comprising inputs 1802-1806. A paste operation can be performed in a destination client application 328b in response to input 1802. In the example embodiment of FIG. 18, input 1802 is a long press of the stylus tip 109 to a target location on a display device 326b while the stylus button 113 is pressed, followed by a release of the button 113. Here, the target location can be conceptualized as part of a canvas 602 or pre-existing presentation displayed on a display device 326b. After the paste operation, the pre-existing canvas 602 is rendered on the display device 326b together with the pasted asset 1704 by the client application 328b. The input 1802 can comprise placing the stylus tip 109 to the canvas with a long press gesture and then releasing the stylus button 113 while the stylus tip 109 remains in contact with canvas. In one embodiment a long press gesture of about 2 seconds in conjunction with pressing and releasing the stylus button 113 will result in the asset 1704 received from the server system 302 being pasted at the selected target location within the client application 328b.

With continued reference to FIG. 18, an input 1804 into an asset navigation interface of client application 328b can be used to select one copied asset 1704 from a plurality of copied assets 1704 available to a computing device 304b via a server-based clipboard. In the example shown in FIG. 18, the stylus tip 109 or another input means can be used to navigate to a particular asset 1704 from a menu or multiple, copied assets 1704. An asset that has been navigated to in a clipboard menu interface of client application 328b can be selected for pasting by pressing the stylus button 113 while placing the stylus tip 109 on the navigated-to asset 1704 with long press gesture and then releasing the button 113 while the stylus tip 109 is still in contact with the navigated-to asset 1704. Once the particular asset 1704 has been selected via input 1804, it can be subsequently pasted into a pre-existing presentation or canvas using input 1806, which can be identical to the input 1802 described above. As shown in FIG. 18, the input 1806 can cause the asset 1704 retrieved from a server-based clipboard to be pasted into a selected target area within the pre-existing canvas 602. FIG. 18 also shows that such a paste operation on the computing device 304b can be performed with more than one input device 111. For example, input 1804 to perform a paste operation for a selected asset 1704 can be received from the stylus input device 111 used to copy the asset to a server-based clipboard or by another input device (not shown). For example, the client application 328b can cause the computing device 304b to scan a data network 306 to discover another stylus input device (not shown) besides the stylus 111. The stylus input device 111 and newly discovered input devices can also communicate with other computing devices, such as the computing device 304b executing a client application 328b. The client application 328b or the stylus input device 111 can provide an identifier for a selected asset 1704 to such a discovered stylus input device via the data network 306. In this way, a discovered and newly paired input device can paste a copied asset 1704 using input 1806, even if discovered input device did not initiate copying of the asset 1704 on the source computing device 304a.

Exemplary Pressure Sensing and Tip Connection Method

FIG. 19 is a flowchart that provides one example of a method for recognizing the input devices described herein. FIG. 19 is described with continued reference to the embodiments illustrated in FIGS. 1-3. However, FIG. 19 is not limited to those embodiments. It is understood that the flowchart of FIG. 19 provides merely an example of the many different types of functional arrangements that may be employed to implement recognition and input differentiation for the input devices and means described herein. For illustrative purposes, the method 1900 is described with reference to the stylus 111 and computing device 304a implementations depicted in FIGS. 1-3. Other implementations, however, are possible. The steps in the method 1900 do not necessarily have to occur in the order shown in FIG. 19 and described below. For example, in embodiments, steps 1902-1908 can be repeated as needed (i.e., when stylus tip is brought into and out of contact with a touch surface) as shown in FIG. 19. According to embodiments, some of the steps shown in FIG. 19 are optional. For example, step 1906 to disconnect a tip may need not be performed if the stylus tip was not already connected (i.e., recognized by the touch surface and providing input).

The method 1900 handles situations where the contact area made by a stylus on a touch surface of a touch computing device may exceed a touch computing device's minimum threshold for recognizing the stylus before the stylus (or a pressure sensor in the stylus) has met its minimum pressure threshold for determining that it is in contact with a touch surface. Similarly, by performing steps 1902-1908, the method 1900 handles situations where the stylus (or its pressure sensor) has met its minimum pressure threshold for determining that it is in contact with a touch surface before the contact area made by the stylus on the touch surface reaches the touch computing device's minimum threshold for recognizing the stylus.

In one embodiment, the result of performing method 1900 is that a touch computing device, such as the computing device 304a, will only detect a contact from the tip 109 when the stylus 111 is reporting pressure wirelessly to the computing device 304a. The reporting can be communicated via the wireless transceiver 336 (i.e., through a Bluetooth transceiver in the stylus 111).

Beginning with step 1902, an input device receives a mechanical force at its tip 109. According to an exemplary embodiment, the stylus 111 is configured to detect changes in pressure using the pressure sensor.

In step 1902, a pressure level corresponding to an applied (or released) force of a stylus tip 109 touching a touch screen, such as touch display device 326a, is determined. As shown in FIG. 19, step 1902 can comprise detecting contact between a tip 109 and determining pressure (i.e., in the contact area made by the stylus tip 109 on a touch surface of a touch computing device). In embodiments, the touch surface can be the touch display device 326a and the touch computing device can be the computing device 304a.

Next, in step 1904, a determination is made as to whether the pressure detected in step 1902 exceeds a threshold. Step 1904 can comprise comparing the detected and determined pressure from step 1902 to a threshold so as to ensure that there is both sufficient pressure and a sufficient contact area for the touch computing device to recognize the stylus 111 and accept input via its tip 109. If it is determined that the pressure threshold has not yet been reached, control is passed to step 1906. Otherwise, if it is determined that the pressure threshold has been reached or exceeded, control is passed to step 1908.

In step 1906, the stylus tip 109 is disconnected (or remains disconnected). It is to be understood that performing step 1906 does not result in a physical disconnection of the tip 109 from the stylus 111. Rather, performing step 1906 results in the touch computing device (momentarily) not accepting input via the tip 109. Alternatively, or in addition, executing step 1906 can result in the stylus 111 not providing input to the touch surface (i.e., the touch display device 326a). This step results in input via the tip 109 not being recognized (or provided) as a result of insufficient pressure being applied.

After the tip is disconnected (or remains disconnected), control is passed back to step 1902.

In step 1908, the stylus tip 109 is connected (or remains disconnected). This step results in input via the tip 109 being recognized as a result of sufficient pressure being applied. Performing step 1906 results in the touch computing device accepting (or continuing to recognize) input via the tip 109.

After the tip is connected (or remains connected), control is passed back to step 1902.

As shown, steps 1902-1908 can be repeated as needed when a stylus tip 109 comes in and out of contact with a touch surface. That is, if a previously detected pressure from step 1902 led to a connection of tip 109 in step 1908, when the tip 109 of the stylus 111 is subsequently lifted from a touch surface and then brought back into contact with the touch surface, control is passed to step 1902 where the method 1900 is repeated.

Exemplary Computer System Implementation

Although exemplary embodiments have been described in terms of charging apparatuses, units, systems, and methods, it is contemplated that certain functionality described herein may be implemented in software on microprocessors, such as a microprocessor chip included in the input devices 111 shown in FIGS. 1-3 and 6-18, and computing devices such as the computer system 2000 illustrated in FIG. 20. In various embodiments, one or more of the functions of the various components may be implemented in software that controls a computing device, such as computer system 2000, which is described below with reference to FIG. 20.

Aspects of the present invention shown in FIGS. 1-19, or any part(s) or function(s) thereof, may be implemented using hardware, software modules, firmware, tangible computer readable media having logic or instructions stored thereon, or a combination thereof and may be implemented in one or more computer systems or other processing systems.

FIG. 20 illustrates an example computer system 2000 in which embodiments of the present invention, or portions thereof, may be implemented as computer-readable instructions or code. For example, some functionality performed by the computing devices 304a and 304b and their respective client applications 328a and 328b shown in FIGS. 3 and 6-18, can be implemented in the computer system 2000 using hardware, software, firmware, non-transitory computer readable media having instructions stored thereon, or a combination thereof and may be implemented in one or more computer systems or other processing systems. Hardware, software, or any combination of such may embody certain modules and components used to implement steps in the method 1900 illustrated by the flowchart of FIG. 19 discussed above and the server system 302 and cloud application 316 discussed above with reference to FIG. 3.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor, a plurality of processors, or combinations thereof. Processor devices may have one or more processor “cores.”

Various embodiments of the invention are described in terms of this example computer system 2000. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 2004 may be a special purpose or a general purpose processor device. As will be appreciated by persons skilled in the relevant art, processor device 2004 may also be a single processor in a multi-core/multiprocessor system, such system operating alone, or in a cluster of computing devices operating in a cluster or server farm. Processor device 2004 is connected to a communication infrastructure 2006, for example, a bus, message queue, network, or multi-core message-passing scheme. In certain embodiments, one or more of the processors 305, 318a, 318b, and 330 described above with reference to the server system 302, computing device 304a, computing device 304b and input device 111 of FIG. 3 can be embodied as the processor device 2004 shown in FIG. 20.

The computer system 2000 also includes a main memory 2008, for example, random access memory (RAM), and may also include a secondary memory 2010. Secondary memory 2010 may include, for example, a hard disk drive 2012, removable storage drive 2014. Removable storage drive 2014 may comprise a floppy disk drive, a magnetic tape drive, an optical disk drive, a flash memory, or the like. In non-limiting embodiments, one or more of the memories 308, 320a, and 320b described above with reference to the server system 302 and computing devices 304a, 304b of FIG. 3 can be embodied as the main memory 2008 shown in FIG. 20.

The removable storage drive 2014 reads from and/or writes to a removable storage unit 2018 in a well known manner. Removable storage unit 2018 may comprise a floppy disk, magnetic tape, optical disk, etc. which is read by and written to by removable storage drive 2014. As will be appreciated by persons skilled in the relevant art, removable storage unit 2018 includes a non-transitory computer readable storage medium having stored therein computer software and/or data.

In alternative implementations, secondary memory 2010 may include other similar means for allowing computer programs or other instructions to be loaded into computer system 2000. Such means may include, for example, a removable storage unit 2022 and an interface 2020. Examples of such means may include a program cartridge and cartridge interface (such as that found in video game devices), a removable memory chip (such as an EPROM, or PROM) and associated socket, and other removable storage units 2022 and interfaces 2020 which allow software and data to be transferred from the removable storage unit 2022 to computer system 2000. In non-limiting embodiments, the memory 332 described above with reference to the input device 111 of FIG. 3 can be embodied as the main memory 2008 shown in FIG. 20. For example, in one non-limiting embodiment, the memory 332 of the input device 111 can be embodied as an EPROM.

Computer system 2000 may also include a communications interface 2024. Communications interface 2024 allows software and data to be transferred between computer system 2000 and external devices. Communications interface 2024 may include a modem, a network interface (such as an Ethernet card), a communications port, a PCMCIA slot and card, or the like. Software and data transferred via communications interface 2024 may be in the form of signals, which may be electronic, electromagnetic, optical, or other signals capable of being received by communications interface 2024. These signals may be provided to communications interface 2024 via a communications path 2026. Communications path 2026 carries signals and may be implemented using wire or cable, fiber optics, a phone line, a cellular phone link, an RF link or other communications channels.

With reference to FIG. 20, a computer readable medium can be embodied in media such as memories, such as main memory 2008 and secondary memory 2010, which can be memory semiconductors (e.g., DRAMs, etc.). A computer readable medium also refer to removable storage unit 2018, removable storage unit 2022, and a hard disk installed in hard disk drive 2012. Signals carried over communications path 2026 can also embody the logic described herein. These computer program products are means for providing software to computer system 2000.

Computer programs (also called computer control logic) are stored in main memory 2008 and/or secondary memory 2010. Computer programs may also be received via communications interface 2024. Such computer programs, when executed, enable computer system 2000 to implement the present invention as discussed herein. In particular, the computer programs, when executed, enable processor device 2004 to implement the processes of the present invention, such as the steps in the method 1900 illustrated by the flowchart of FIG. 19, discussed above. Accordingly, such computer programs represent controllers of the computer system 2000. Where the invention is implemented using software, the software may be stored in a computer program product and loaded into computer system 2000 using removable storage drive 2014, interface 2020, and hard disk drive 2012, or communications interface 2024.

In an embodiment, the display devices 326a, 326b used to display interfaces of client applications 328a and 328b, respectively, may be a computer display 2030 shown in FIG. 20. The computer display 2030 of computer system 2000 can be implemented as a touch sensitive display (i.e., a touch screen). Similarly, the user interfaces shown in FIGS. 6-18 may be embodied as a display interface 2002 shown in FIG. 20.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

### General Considerations

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A computer implemented method comprising:
detecting a touch input by receiving a physical contact made at a touch surface of a computing device;
identifying whether the touch input was received from a stylus based on additional input received from the stylus; and
responding to the touch input with a response, wherein the response differs based on whether the touch input was received from the stylus; and
wherein the detecting, identifying and responding are performed at the computing device.

2. The method of claim 1, wherein the identifying comprises associating the touch input with one of the stylus, a finger, multiple fingers, and a palm.

3. The method of claim 1, further comprising receiving, from the stylus, a pressure level corresponding to the detected touch input, wherein the identifying comprises identifying whether the touch input was received from the stylus based at least in part on the pressure level.

4. The method of claim 1, further comprising receiving, from the stylus, a pressure level corresponding to the detected touch input, wherein the identifying comprises determining that the pressure level meets a predetermined pressure level threshold associated with the stylus.

5. The method of claim 1, further comprising receiving, from the stylus, a pressure level received via a capacitive tip of the stylus, wherein the identifying comprises determining that the pressure level meets a predetermined pressure level threshold associated with the stylus.

6. The method of claim 1, further comprising determining a contact area corresponding to the detected touch input, wherein the identifying comprises identifying whether the touch input was received from the stylus based at least in part on the contact area.

7. The method of claim 1, further comprising receiving, from the stylus, a second input comprising timing data, wherein the identifying comprises identifying whether the touch input was received from the stylus based at least in part on the timing data.

8. The method of claim 1, further comprising receiving, from the stylus, a second input indicating timing information, wherein the identifying comprises one or more of identifying receipt of the second input as being a within a threshold time span of a time that the touch input was received and identifying a synchronization between a clock of the computing device and a clock of the stylus.

9. The method of claim 1, wherein the additional input is received wirelessly from a wireless transceiver of the stylus.

10. The method of claim 1, wherein the identifying is based at least in part on a determined pressure level reaching a predefined threshold and a timestamp received from the stylus.

11. A computer implemented method comprising:
detecting a touch input by receiving a physical contact at a touch surface of a computing device;
determining a pressure level corresponding to the detected touch input;
associating, based at least in part on the pressure level, the touch input with a type of touch input; and
responding to the touch input with a response, wherein the response differs based on the type of the touch input; and
wherein the detecting, determining, associating, and responding are performed by the computing device.

12. A computer implemented method comprising:
detecting a first touch input and a second touch input, the first touch input detected by receiving a physical contact at a touch surface of a computing device, the second touch input detected by receiving a second physical contact at the touch surface of the computing device;
associating the first touch input with a first type of touch input and the second type of touch input with a second type of touch input different from the first type; and
responding to first touch input and the second touch input with a response based on the first type and the second type; and
wherein the detecting, determining, associating, and responding are performed by the computing device.

13. The method of claim 12, further comprising identifying a workflow based on the first type and the second type.

14. The method of claim 13, wherein the workflow comprises operations in an application executing on the computing device for at least one of:
an erasure;
an undo operation;
a redo operation;
a brush size selection;
a brush opacity selection;
a selection of a line angle constraint;
a menu navigation;
a menu selection;
a copy operation; and
a paste operation.

15. The method of claim 12, wherein the associating comprises associating the first touch input with a stylus and associating the second type of touch input with one of a finger, multiple fingers, and a palm.

16. The method of claim 12 wherein the detecting comprises detecting that the first touch input and the second touch input occur simultaneously.

17. The method of claim 12 wherein the detecting comprises detecting that the first touch input and the second touch input occur sequentially.

18. A computer readable medium having instructions stored thereon, that, if executed by a processor of a computing device, cause the computing device to perform operations for differentiating input received at a touch surface of the computing device, the instructions comprising:
instructions for detecting a touch input by receiving a physical contact made at the touch surface of the computing device;
instructions for identifying whether the touch input was received from a stylus based on additional input received from the stylus; and
instructions for responding to the touch input with a response, wherein the response differs based on whether the touch input was received from the stylus.

19. The computer readable medium of claim 18, wherein the instructions for identifying comprise instructions for receiving the additional input as being a within a threshold time span of a time that the touch input was received.

20. The computer readable medium of claim 18, further comprising:
instructions for detecting a second touch input by receiving a second physical contact made at the touch surface of the computing device;
instructions for determining that the second touch input was not received from another input means different than the stylus based on not receiving additional input from the another input means a within a threshold time span of a time that the touch input was received.

21. A stylus comprising:
a capacitive tip configured to interact with a touch surface of a computing device;
a wireless transceiver configured to communicate with the computing device;
a pressure sensor configured to determine a level of pressure received at the tip;
a processor; and
a computer readable medium having logic encoded thereon, that if executed by the processor, cause the processor to perform operations comprising:
determining if a level of pressure measured by the pressure sensor has reached a predetermined threshold;
suppressing capacitive output from the tip to the touch surface if the determining determines that the threshold has not been reached; and
communicating a message to the computing device based on determining that the threshold has been reached.

22. The stylus of claim 21, wherein the tip is configured to deliver a pressure stream to the computing device, the operations further comprising:
modulating the pressure stream by delivering the pressure stream in response to determining that threshold has been reached.

23. The stylus of claim 21, wherein the pressure sensor is configured to determine the level of pressure when the tip is in physical contact with the touch surface, the stylus further comprising:
wirelessly communicating, via the wireless transceiver, one or more of a timestamp corresponding to the physical contact with the touch surface and a timestamp corresponding to the communicating of the level of pressure, to the computing device.
